(19) United States
(12) Patent Application Publication
(10) Pub. No.: US 2006/0243399 A1
(43) Pub. Date: Nov. 2, 2006

(54) End fastener for fixing the pull cord of a transverse blind

(75) Inventors: Ming Nien, Taichung (TW); Yu-Che Wen, Taichung (TW)

Correspondence Address: TROXELL LAW OFFICE PLLC, SUITE 1404, 5205 LEESBURG PIKE, FALLS CHURCH, VA, 22041, US

(73) Assignee: Nien Made Enterprise Co., Ltd.

(21) Appl. No.: 11/117,366

(22) Filed: Apr. 29, 2005

(51) Int. Cl. E06B 9/388

(52) U.S. Cl. 160/173 R

(57) ABSTRACT

An end fastener for fixing the pull cord of a transverse blind is bored with a vertical insert hole in the center and a plurality of diametrical fitting notches in the circumferential wall. After the pull cord of the transverse blind is inserted through the vertical insert hole of the end fastener, it is turned to be wound around the opposite sides of the end fastener and fitted in the fitting notches to let the end fastener movably secured stably in position. Thus, by adjusting the position of the end fastener on the pull cord, the position of the lower rod of a transverse blind can be controlled to adjust the vertical length of the transverse blind for matching with the real height of a window.

### BACKGROUND OF THE INVENTION

1. Field of the Invention

This invention relates to an end fastener for fixing the pull cord of a blind, particularly to one able to movably fix the pull cord of a transverse Venetian blind and easily control the position of the lower frame of the transverse blind for adjusting the vertical length of the transverse blind to match with the real height of a window.

2. Description of the Prior Art

A conventional transverse Venetian blind is provided with an upper rod, a lower rod, a lot of slats and two pull cords. The slats orderly arranged between the upper and the lower rod are series connected together by the two pull cords that respectively have one end secured at the underside of one end of the lower rod and the other end is orderly threaded upward through all the slats as well as the upper rod and then extended downward to be pulled up and down and also changing the angles of slats. Usually, the pull cord must have its lower end inserted through both the lower rod and the vertical insert hole of an end fastener positioned at the underside of the lower rod and then has its lower end tied in a knot to let the knot firmly engaged on the circumferential wall of the insert hole of the end fastener and the lower rod positioned on the end fattener.

However, common windows are different in size; therefore, after a transverse blind is assembled on a window, its lower rod usually has to be adjusted in position for matching with the real height of the window so as to obtain excellent effects of light blocking and esthetic appearance. Nevertheless, the cord knot positioned under the lower rod is difficult to be unfastened; therefore, once a transverse blind is assembled on a window but its lower rod is found positioned improperly, it is not easy to unfasten the knot of the pull cord and adjust the position of the lower rod, causing much inconvenience in adjusting of the position of a transverse Venetian blind and resulting in affecting function of light blocking.

### SUMMARY OF THE INVENTION

The objective of this invention is to offer an end fastener for fixing the pull cord of a transverse blind, having its center bored with a vertical insert hole for the pull cord threaded through a lower rod to be inserted therethrough and its circumferential wall equidistantly and diametrically cut with a plurality of fitting notches for the pull cord inserted through the central insert hole of the end fastener to be wound and fitted therein. The end fastener of this invention can movably secure stably the pull cord in position quickly and also can easily be separated from the pull cord to adjust the position of the lower rod and the vertical length of the transverse blind for matching with the real height of the window.

### BRIEF DESCRIPTION OF DRAWINGS

This invention will be better understood by referring to the accompanying drawings, wherein:

FIG. 1 is a perspective view of an end fastener for fixing the pull cord of a transverse blind the present invention:

FIG. 2 is a perspective view of a transverse blind having the end fastener assembled thereon in the present invention:

FIG. 3 is a perspective view of the end fastener movably engaged with a pull cord in the present invention: and

FIG. 4 is a side view of the end fastener, the pull cord and a lower rod combined with one another in the present invention.

### DETAILED DESCRIPTION OF THE PREFERRED EMBODIMENT

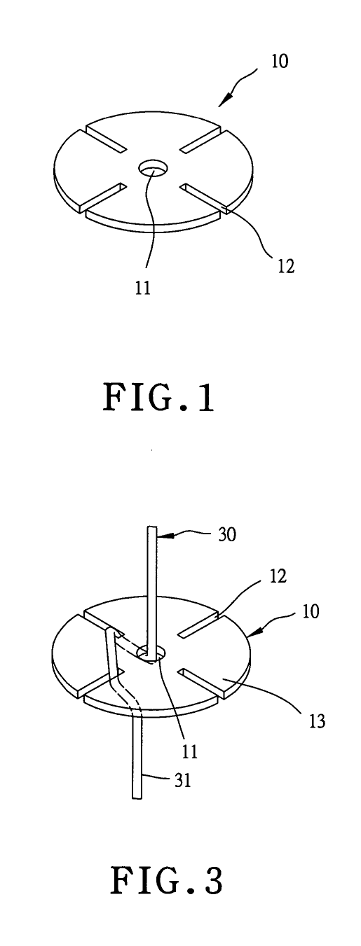

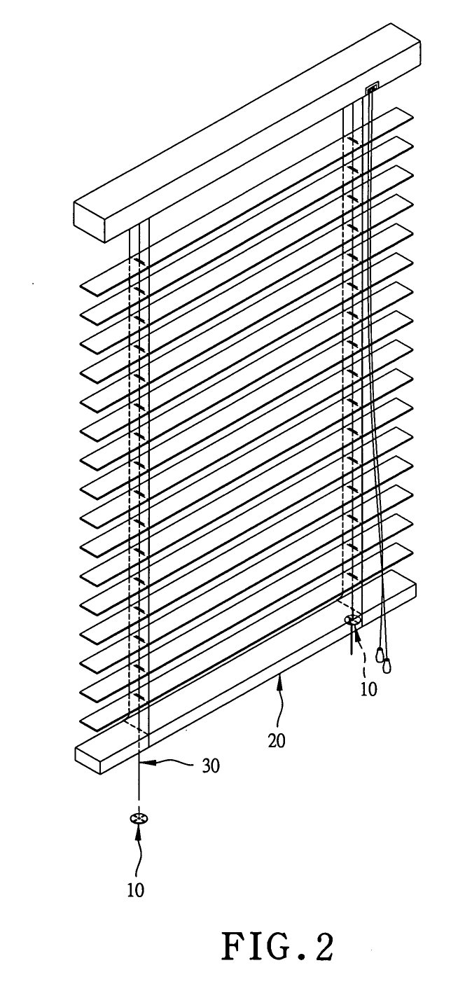

A preferred embodiment of an end fastener for fixing the pull cord of a transverse blind in the present invention, as shown in FIGS. 1 and 2, is to be assembled at the underside of the lower rod 20 of a transverse blind for connecting and fixing the lower end of a pull cord 30, which is inserted through the lower rod 20, and positioning the lower rod 20.

The end fastener 10 is shaped as a disk and has its central portion bored with a vertical insert hole 11 for the pull cord 30 threaded through the lower rod 20 to be inserted therethrough and its circumferential wall equidistantly and diametrically cut with four fitting notches 12 respectively having a width approximately equivalent to the diameter of the pull cord 30. Thus, the pull cord 30 is inserted through the vertical insert hole 11 of the end fastener 10, which can be movably secured stably with the pull cord 30 winding around the end fastener 10 and fitting in different fitting notches 12 of the end fastener 10.

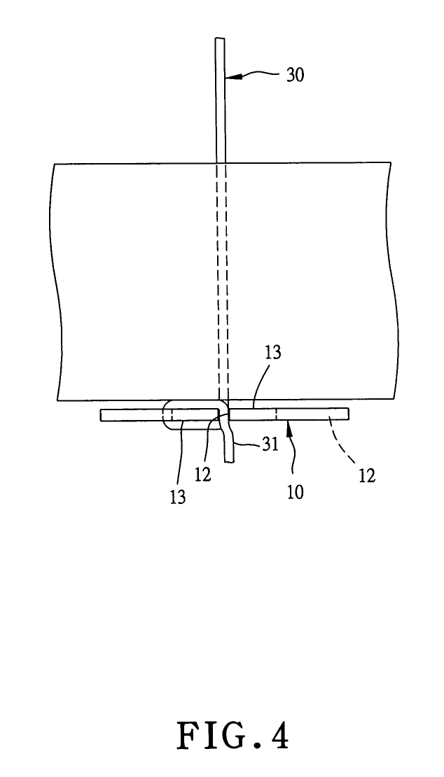

In assembling, as shown in FIGS. 3 and 4, the pull cord 30, after threaded through the lower rod 20, has its lower end inserted through the vertical insert hole 11 of the end fastener 10, which is pushed to move upward alone or together with the lower rod 20 along the pull cord 30 until it reaches to a proper location. Next, the pull cord 30 has its extending-out portion 31 passing over the underside of the end fastener 10 and fitted in any one of the four engage notches 12 and then turned and fitted in another engage notch 12. Thus, the extending-out portion 31 of the pull cord 30 is turned for 90 degrees at several locations on the opposite sides of the end fastener 10 and fitted in two adjacent fitting notches 12 of the end fastener 10; therefore, the end fastener can be movably secured with pull cord 30 easily and quickly. Since the end fastener 10 is movably secured with the pull cord 30, the pull cord 30 can easily be unfastened and the end fastener 10 can easily be adjusted in position to change the position of the lower rod 20 and adjust the vertical length of the transverse blind for matching with the real height of a window.

As can be understood from the above description, this invention has the following advantages.

1. The pull cord 30 is turned to be movably fitted around the opposite sides fitting in two notches 12 in the circumferential wall of the end fastener 10; therefore, the end fastener 10 can be assembled and operated easily and quickly.

2. Being movably secured with the pull cord 30, the end fastener 10 can be adjusted in position on the pull cord 30 to control the position of the lower rod if necessary. Thus, the transverse blind can be adjusted in length for matching with the real height of a window.

3. The end fastener 10 of this invention is simple in structure and easy in producing.

4. The end fastener 10 of this invention is applicable to honeycomb-shaped blinds, folding blinds or other transverse blinds.

While the preferred embodiment of the invention has been described above, it will be recognized and understood that various modifications may be made therein and the appended claims are intended to cover all such modifications that may fall within the spirit and scope of the invention.

I claim:

1. An end fastener for fixing the pull cord of a transverse blind assembled at the underside of the lower rod of a transverse blind, said end fastener connecting and fixing the end of a pull cord threaded through said lower rod, said end fastener fixing said lower rod in position: and,
characterized by said end fastener bored with a vertical insert hole in the center and a plurality fitting notches in the circumferential wall, said pull cord inserted through said vertical insert hole of said end fastener to be turned and fitted in said fitting notches, said end fastener movably secured stably with said pull cord.

2. The end fastener for fixing the pull cord of a transverse blind as claimed in claim 1, wherein said end fastener is disk-shaped and has its circumferential wall cut with four fitting notches.

3. The end fastener for fixing the pull cord of a transverse blind as claimed in claim 1, wherein the width of said engage notch of said end fastener is approximately equivalent to the diameter of said pull cord.

4. The end fastener for fixing the pull cord of a transverse Venetian blind as claimed in claim 1, wherein said fitting notches of said end fastener are cut diametrically.
